(19) United States
(12) Patent Application Publication
(10) Pub. No.: US 2006/0239140 A1
(43) Pub. Date: Oct. 26, 2006

(54) Optical apparatus

(76) Inventors: Takehiko Sato, Utsunomiya-shi (JP); Shigeo Nakashima, Utsunomiya-shi (JP)

Correspondence Address: MORGAN & FINNEGAN, L.L.P., 3 WORLD FINANCIAL CENTER, NEW YORK, NY, 10281-2101, US

(21) Appl. No.: 11/404,244

(22) Filed: Apr. 13, 2006

(30) Foreign Application Priority Data
Apr. 22, 2005 (JP) 2005-125749

(51) Int. Cl. G11B 7/00

(52) U.S. Cl. 369/44.28

(57) ABSTRACT

A compact optical apparatus with a high durability is disclosed. The optical apparatus comprises a first lens which is moved in an optical axis direction for varying magnification, and a second lens which is moved in the optical axis direction for focusing. The apparatus further comprises a vibration type linear actuator which drives the first lens with vibration produced through an electromechanical energy conversion action, and an electromagnetic type linear actuator which drives the second lens with electromagnetic power.

### BACKGROUND OF THE INVENTION

The present invention relates to an optical apparatus having a driving source for driving a lens in an optical axis direction, and particularly, to an optical apparatus which includes a vibration type linear actuator for use as a driving source.

Some optical apparatuses include a vibration type linear actuator for use as a driving source for driving a lens (for example, see Japanese Patent Laid-Open No. 10(1998)-90584).

In the optical apparatuses proposed in Japanese Patent Laid-Open No. 10(1998)-90584 having the vibration type linear actuator, the vibration type linear actuator is formed of a vibrator which produces vibration through an electromechanical energy conversion action and a contact member which is in press contact with the vibrator.

In the vibration type linear actuator, the vibrator is fixed to a lens holding member, the contact member is fixed to a stationary member of a lens barrel, and the vibrator is caused to produce a driving vibration, thereby moving the lens holding member together with the vibrator, or the contact member is fixed to the lens holding member, the vibrator is fixed to the stationary member of the lens barrel, and the vibrator is caused to produce a driving vibration, thereby moving the lens holding member together with the contact member.

In the optical apparatuses proposed in Japanese Patent Laid-Open No. 10(1998)-90584, such vibration type linear actuators are used to drive two lenses for varying magnification and focusing, respectively. The vibration type linear actuator is easier to miniaturize than an electromagnetic type linear actuator which generates driving force by magnetic force generated by a coil facing a magnet, and therefore using the vibration type linear actuator is very effective in reducing the size of the optical apparatus.

However, the vibration type linear actuator operates in a state in which the vibrator and the contact member are in press contact with each other, so that they are easy to wear.

Further, the focusing lens driven for correcting image plane changes associated with varied magnification and for auto focusing is often driven as compared with the magnification-varying lens, generally. Therefore, when the vibration type linear actuator is used to drive the focus lens, the wear thereof progresses faster than the vibration type linear actuator for driving the magnification-varying lens. This causes a possibility that the durability of the optical apparatus be deteriorated.

### BRIEF SUMMARY OF THE INVENTION

It is an object of the present invention to provide a compact optical apparatus with a high durability.

According to an aspect, the present invention provides an optical apparatus comprises a first lens which is moved in an optical-axis direction for varying magnification, and a second lens which is moved in the optical axis direction for focusing. The apparatus further comprises a vibration type linear actuator which drives the first lens with vibration produced through an electromechanical energy conversion action, and an electromagnetic type linear actuator which drives the second lens with electromagnetic power.

Other objects and features of the present invention will become readily apparent from the following description of the preferred embodiments with reference to accompanying drawings.

### BRIEF DESCRIPTION OF THE DRAWINGS

FIGS. 1A to 1D show the structure of a lens barrel of an image-taking apparatus which is an embodiment of the present invention when viewed from four directions.

FIG. 2 is a section view showing the lens barrel in the embodiment taken along a plane in parallel with an optical axis.

FIG. 3 is a section view showing the lens barrel in the embodiment taken along a plane perpendicular to the optical axis.

FIG. 4 is a section view showing the lens barrel in the embodiment taken along a plane perpendicular to the optical axis.

FIG. 5 is an exploded perspective view showing the lens barrel in the embodiment.

FIG. 6 is a block diagram showing the electrical structure of the image-taking apparatus of the embodiment.

### DETAILED DESCRIPTION OF THE PREFERRED EMBODIMENTS

A preferred embodiment of the present invention will hereinafter be described with reference to the drawings.

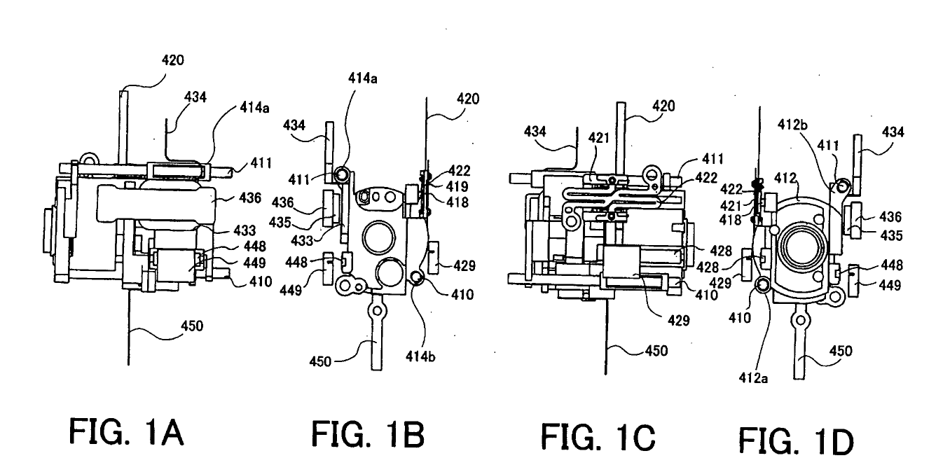

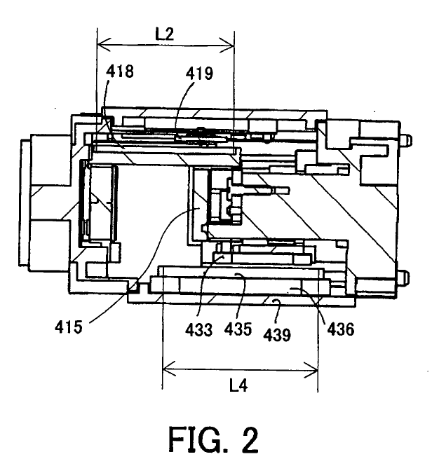

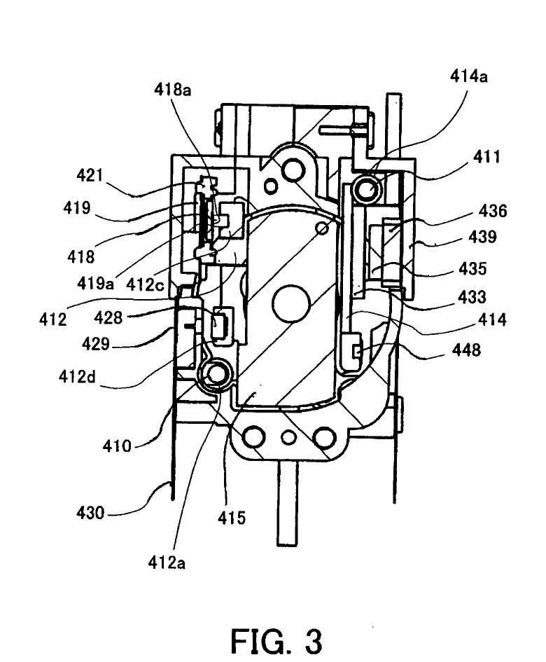

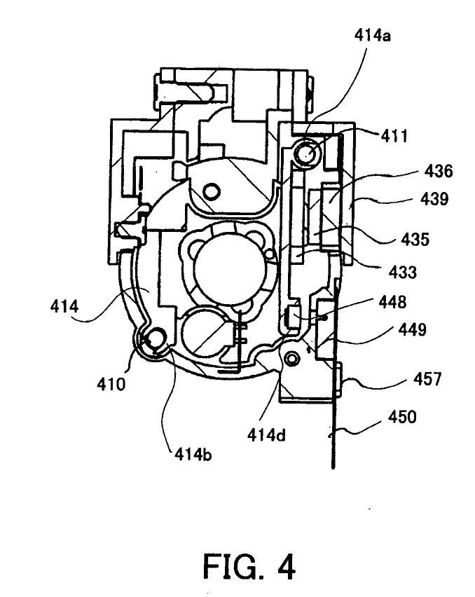

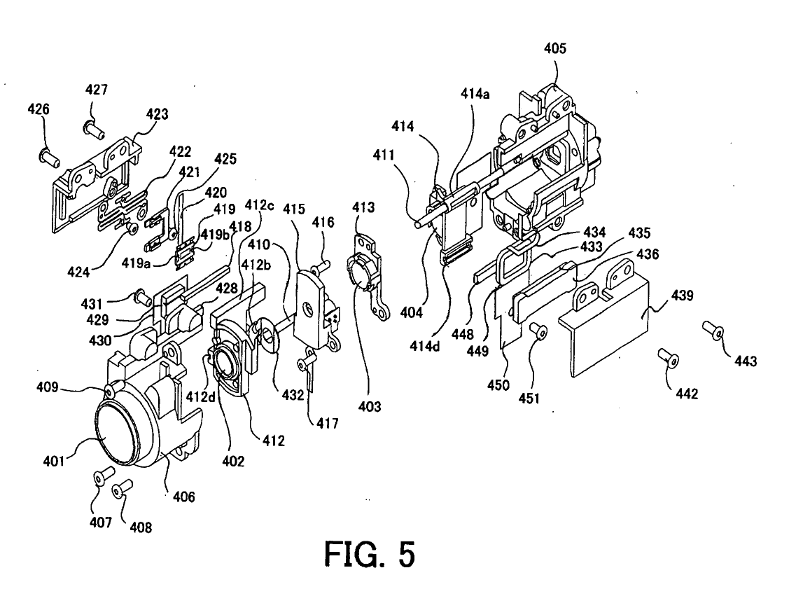

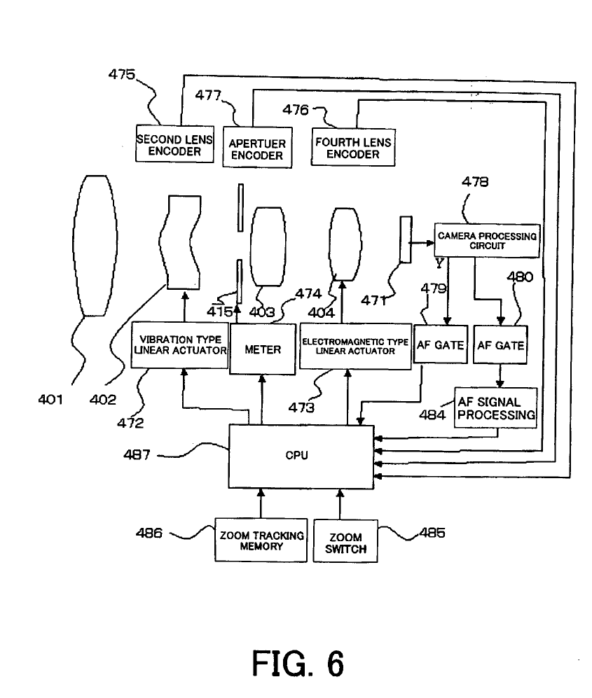

FIGS. 1A to 5 show the structure of a lens barrel of an image-taking apparatus which is an embodiment of the present invention. FIGS. 1A to 1D show the lens barrel in this embodiment, with its exterior removed, when viewed from four directions, the right, back, left, and front, respectively. FIG. 2 shows a section view of the lens barrel in this embodiment taken along a plane in parallel with an optical axis and perpendicular to a press contact surface between a slider and a vibrator of a vibration type linear actuator. FIG. 3 shows a section view of the lens barrel in this embodiment taken along a plane perpendicular to the optical axis and perpendicular to a press contact surface of a vibration type linear actuator for driving a second lens unit when viewed from an object side. FIG. 4 shows a section view of the lens barrel in this embodiment taken along a plane perpendicular to the optical axis and perpendicular to a press contact surface of a vibration type linear actuator for driving a fourth lens unit when viewed from the object side. FIG. 5 is an exploded view showing the lens barrel in this embodiment. FIG. 6 shows an electrical structure of the image-taking apparatus of this embodiment.

In FIGS. 1A to 6, in order from the object side, reference numerals 401 shows a fixed first lens unit, 402 the second lens unit which is movable in the optical axis direction for varying magnification, 415 a light amount adjusting unit, 403 a fixed third lens unit, and 404 the fourth lens unit which is movable in the optical axis direction for correcting image plane changes associated with varied magnification and for focal adjustment.

Reference numeral 405 shows a rear barrel which holds an image-pickup device, later described, and a low pass filter (LPF), and is fixed to a camera body, not shown. Reference numeral 406 shows a first lens holding member which holds the first lens unit 401 and is fixed to the rear barrel 405 by screws 407, 408, and 409.

Reference numerals 410 and 411 show guide bars (guide members) which are held substantially in parallel with the optical axis direction by the rear barrel 405 and the first lens holding member 406.

Reference numeral 412 shows a second lens holding member which holds the second lens unit 402 and to which a mask 432 for cutting unnecessary light is fixed. The second lens holding member 412 engages with the guide bar 410 at an engaging portion 412a to be guided in the optical axis direction and engages with the guide bar 411 at an engaging portion 412b to be prevented from rotation around the guide bar 410. Reference numeral 413 shows a third lens holding member which holds the third lens unit 403 and is fixed to the rear barrel 405 by a screw 416. Reference numeral 414 shows a fourth lens holding member which holds the fourth lens unit 404, and engages with the guide bar 411 at an engaging portion 414a to be guided in the optical axis direction and engages with the guide bar 410 at an engaging portion 414b to be prevented from rotation around the guide bar 411.

The light amount adjusting unit 415 has an outer shape which is longer in a vertical direction (first direction) than in a horizontal direction (second direction) when viewed from the optical axis direction. The light amount adjusting unit 415 is fixed to the rear barrel 405 by a screw 417. Although the details of the light amount adjusting unit 415 are not shown in the figures, the light amount adjusting unit 415 is a so-called guillotine type aperture stop in which a pair of aperture blades are substantially translated vertically by a lever rotated by a meter to increase or reduce the diameter of the aperture.

Reference numeral 418 shows a slider which is formed of a magnet and a friction material bonded to each other and is fixed into a square hole 412c in the second lens holding member 412 through adhesion or the like.

Reference numeral 419 shows a vibrator which is formed of an electromechanical energy conversion element and a plate-shaped elastic member on which vibration is produced by the electromechanical energy conversion element. The elastic member of the vibrator 419 is made of ferromagnet which is attracted by the magnet of the slider 418 to bring an press contact surface 418a of the friction material of the slider 418 into press contact with press contact surfaces 419a and 419b formed at two positions in the optical axis direction in the elastic member of the vibrator 419.

Reference numeral 420 shows a flexible wiring board which is connected to the vibrator 419 and transmits a signal to the electromechanical energy conversion element.

In a first linear actuator (vibration type linear actuator) formed of the slider 418 and the vibrator 419, while the slider 418 is in press contact with the vibrator 419, two frequency signals (pulse signals or alternate signals) in difference phases are input to the electromechanical energy conversion element through the flexible wiring board 420 to create a substantially elliptic motion in the press contact surfaces 419a and 419b of the vibrator 419 to produce driving force in the optical axis direction in the press contact surface 418a of the slider 418.

Reference numeral 421 shows a spacer to which the vibrator 419 is fixed, and 422 a plate spring to which the spacer 421 is fixed. The plate spring 422 has a shape which is not easily deformed in the in-plane direction, is easily deformed in the direction perpendicular to the plane, and is easily deformed in the rotation direction around an arbitrary axis included in the plane. The plate spring 422 not easily deformed in the in-plane direction limits displacement of the vibrator 419 in the optical axis direction (that is, the driving direction).

Reference numeral 423 shows a vibrator frame to which the plate spring 422 is fixed by screws 424 and 425. The vibrator frame 423 is fixed to the first lens holding member 406 by screws 426 and 427.

Reference numeral 428 shows a scale which detects the position of the second lens holding member 412 and is fixed into a square hole 412d in the second lens holding member 412 through adhesion or the like.

Reference numeral 429 shows a light transmitter/receiver element which applies light to the scale 428 and receives the light reflected by the scale 428 to detect the moving amount of the second lens holding member 412. The scale 428 and the light transmitter/receiver element 429 constitute a first linear encoder serving as a detector.

Reference numeral 430 shows a flexible wiring board which sends and receives a signal to and from the light transmitter/receiver element 429 and is fixed to the first lens holding member 406 by a screw 431.

As shown in FIG. 3, the guide bar 410, the first linear actuator formed of the vibrator 419 and the slider 418, and the first linear encoder formed of the light transmitter/receiver element 429 and the scale 428 are arranged along or close to a planar left side of the light amount adjusting unit 415 (linear long side on the left when viewed from the optical axis direction) that is one of the outer surfaces closest to the optical axis position of the light amount adjusting unit 415 of all of the outer surfaces thereof when viewed from the front of the optical axis direction. In this embodiment, the guide bar 410, the first linear encoder, and the first linear actuator are disposed in order from the bottom and next to each other.

Reference numeral 433 shows a coil which is fixed to the fourth lens holding member 414. Reference numeral 434 shows a flexible wiring board for transmitting a signal to the coil 433. The flexible wiring board 434 is deformed as the fourth lens holding member 414 is moved in the optical axis direction.

Reference numerals 435 and 436 show a magnet and a yoke, respectively. The coil 433, the magnet 435, and the yoke 436 constitute a magnetic circuit, in which the coil 433 is energized to form a second linear actuator (voice coil motor) which is an electromagnetic type linear actuator which produces driving force in the optical axis direction. Reference numeral 439 shows a yoke holding member which holds the yoke 436 and is fixed to the rear barrel 405 by screws 442 and 443.

As shown in FIG. 2, the range in which the first linear actuator is placed in the optical axis direction (the range in which the slider 418 is placed) and a movable range L2 of the second lens holding member 412 in the optical axis direction extend from the object side (the left in FIG. 2) of the light amount adjusting unit 415 toward the image plane side. The range in which the second linear actuator is placed in the optical axis direction (the range in which the magnet 435 is placed) and a movable range L4 of the fourth lens holding member 414 in the optical axis direction extend from the image plane side of the light amount adjusting unit 415 toward the object side. In other words, the ranges in which the first and second linear actuators are placed (the movable ranges of the second and fourth lens holding members 412 and 414) overlap each other in the optical axis direction.

Reference numeral 448 shows a scale which detects the position of the fourth lens holding member 414 and is fixed into a square hole 414d in the fourth lens holding member 414 through adhesion or the like. Reference numeral 449 shows a light transmitter/receiver element which applies light to the scale 448 and receives the light reflected by the scale 448 to detect the moving amount of the fourth lens holding member 414. Reference numeral 450 shows a flexible wiring board which is used to send and receive a signal to and from the light transmitter/receiver element 449 and is fixed to the rear barrel 405 by a screw 451.

As shown in FIG. 4, the guide bar 411, the second linear actuator formed of the coil 433, the magnet 435, and the yoke 436, and the second linear encoder formed of the light transmitter/receiver element 449 and the scale 448 are arranged along or close to a planar right side of the light amount adjusting unit 415 (linear long side on the right when viewed from the optical axis direction) that is one of the outer surfaces closest to the optical axis position of the light amount adjusting unit 415 of all of the outer surfaces thereof when viewed from the front of the optical axis direction. In this embodiment, the guide bar 411, the second linear actuator, and the second linear encoder are disposed in order from the top and next to each other.

The set of the guide bar 410, the first linear actuator, and the first linear encoder, and the set of the guide bar 411, the second linear actuator, and the second encoder are arranged substantially point-symmetrically with respect to the optical axis. To be point-symmetric in a strict sense, for example, the guide bar 411, the second linear encoder, and the second linear actuator should be disposed in this order from the top on the side of the guide bar 411, but the arrangement of this embodiment may be considered to be substantially point-symmetric if the guide bars, the linear actuators, and the linear encoders are seen individually. The guide bar 411 and the second linear actuator disposed next to each other as in this embodiment can drive the fourth lens holding member 414 more smoothly as compared with the case where the guide bar 411 and the second linear actuator are disposed apart, as later described. However, a strictly point-symmetric arrangement may be used.

In FIG. 6, reference numeral 471 shows the image-pickup device formed of a CCD sensor, a CMOS sensor or the like. Reference numeral 472 shows the vibration type linear actuator which includes the slider 418 and the vibrator 419, and serves as a driving source of the second lens unit 402 (second lens holding member 412). Reference numeral 473 shows the electromagnetic type linear actuator which is formed of the coil 433, the magnet 435, and the yoke 436, and serves as a driving source of the fourth lens unit 404 (fourth lens holding member 414).

Reference numeral 474 shows a meter which serves as a driving source of the light amount adjusting unit 415. Reference numeral 475 shows a second lens encoder realized by the first linear encoder which includes the scale 428 and the light transmitter/receiver element 429, 476a fourth lens encoder realized by the second linear encoder which includes the scale 448 and the light transmitter/receiver element 449. These encoders detect the relative positions (moving amounts from a reference position) of the second lens unit 402 and the fourth lens unit 404 in the optical axis direction, respectively. While this embodiment employs optical encoders as the encoders, it is possible to use a magnetic encoder or an encoder which detects an absolute position by using electrical resistance.

Reference numeral 477 shows an aperture encoder which is, for example, of the type in which a hole element is provided within the meter 474 as the driving source of the light amount adjusting unit 415 and is used to detect a rotational position relationship between a rotor and a stator of the meter 474.

Reference numeral 487 shows a CPU serving as a controller responsible for control of operation of the image-taking apparatus. Reference numeral 478 shows a camera signal processing circuit which performs amplification, gamma correction or the like on the output from the image-pickup device 471. After the predetermined processing, a contrast signal of a video signal is transmitted through an AE gate 479 and an AF gate 480. The gates 479 and 480 set an optimal range in the entire screen for extracting the signal for exposure setting and focusing. These gates 479 and 480 may have variable sizes, or a plurality of gates 479 and 480 may be provided.

Reference numeral 484 shows an AF (auto-focus) signal processing circuit for auto-focus which extracts a high-frequency component of the video signal to produce an AF evaluation value signal. Reference numeral 485 shows a zoom switch for zooming operation. Reference numeral 486 shows a zoom tracking memory which stores information about target positions to which the fourth lens unit 404 is to be driven in accordance with the camera-to-object distance and the position of the second lens unit 402 in order to maintain an in-focus state in varying magnification. Memory in the CPU 487 may be used as the zoom tracking memory.

In the abovementioned structure, when a user operates the zoom switch 485, the CPU 487 controls the vibration type linear actuator 472 for driving the second lens unit 402 and calculates the target driving position of the fourth lens unit 404 based on the information in the zoom tracking memory 486 and the current position of the second lens unit 402 determined from the detection result of the second lens unit encoder 475 to control the electromagnetic type linear actuator 473 for driving of the fourth lens unit 404 to that target driving position. Whether or not the fourth lens unit 404 has reached the target driving position is determined by the matching of the current position of the fourth lens unit 404 provided from the detection result of the fourth lens unit encoder 476 with the target driving position.

In the auto-focus, the CPU 487 controls the electromagnetic type linear actuator 473 to drive the fourth lens unit 404 to search for the position where the AF evaluation value determined by the AF signal processing circuit 484 is at the peak.

To provide appropriate exposure, the CPU 487 controls the meter 474 of the light amount adjusting unit 415 to increase or reduce the aperture diameter such that the average value of the luminance signal through the AE gate 479 is equal to a predetermined value, that is, such that the output from the aperture encoder 477 has a value corresponding to the predetermined value.

In the abovementioned structure, the slider 418 is formed by using the magnet which attracts the vibrator 419 to provide the press contact force necessary for producing the driving force as the vibration type linear actuator. Thus, any reaction force of the press contact force does not act on the second lens holding member 412. As a result, the frictional force produced at the engaging portions 412a and 412b of the second lens holding member 412 engaging with the guide bars 410 and 411 is not increased and the driving load due to the friction is not increased. In addition, the plate spring 422 produces small force, so that the force acting from the plate spring 422 on the engaging portions 412a and 412b engaging with the guide bars 410 and 411 is small and hardly increases the frictional force produced at the engaging portions 412a and 412b. This enables the use of the low-power and small vibration type linear actuator, resulting in a reduction in size of the lens barrel.

Since large press contact force does not act on the second lens holding member 412, the frictional force produced at the engaging portions 412a and 412b of the second lens holding member 412 engaging with the guide bars 410 and 411 is not increased. The power or size of the first linear actuator does not need to be increased, and the wear due to the friction between the guide bars 410, 411 and the engaging portions 412a, 412b can be reduced. Also, the fine driving of the second lens holding member 412 (second lens unit 402) can be accurately achieved.

Even when a manufacturing error or the like changes the position of any press contact surface with respect to an axis in parallel with the optical axis or the inclination around that axis in the optical axis direction, the plate spring 422 is deformed to change the position or inclination (orientation) of the vibrator 419 to maintain both of the press contact surfaces in parallel with each other, thereby holding an appropriate contact state between the surfaces. The plate spring 422 has a spring constant set such that it is deformed in response to a smaller force than the abovementioned press contact force. The press contact force is not changed greatly even when the position or inclination of any press contact surface is changed. Consequently, it is possible to provide stably an output consistent with the performance inherent in the first linear actuator.

The vibration type linear actuator is not displaced even when it is not powered since the vibrator is always in press contact with the slider. Particularly, the second lens unit 402 is moved only in varying magnification and often stationary, so that the use of the vibration type linear actuator for driving the second lens unit can save power as compared with the linear actuator using electromagnetic force.

On the other hand, in the linear actuator using electromagnetic force, no contact portion is provided and thus no portion is worn. Since force is produced only in the driving direction and any lateral pressure does not act on the driven member (fourth lens holding member 414), any lateral pressure does not act on the engaging portions 414a and 414b of the driven member engaging with the guide bars 411 and 410, and the engaging portions 414a and 414b are hardly worn. Particularly, the fourth lens unit is moved in varying magnification and focusing, and its moving amount is larger than that of the second lens unit due to the AF operation. Therefore, the electromagnetic type linear actuator is more effective for use in driving the fourth lens unit than the vibration type linear actuator in order to enhance the durability.

As described above, in this embodiment, the guide bar 410, the first linear actuator, and the first linear encoder are disposed next to each other along (close to) the left side which is one of the outer surfaces of the light amount adjusting unit 415 closest to the optical axis position when viewed from the optical axis direction. The guide bar 411, the second linear actuator, and the second linear encoder are disposed next to each other along (close to) the right side which is one of the outer surfaces of the light amount adjusting unit 415 closest to the optical axis position when viewed from the optical axis direction. Thus, although the optical apparatus has the light amount adjusting unit 415, the two linear actuators for driving the second and fourth lens holding members 412 and 414 (second and fourth lens units 402 and 404) disposed on the object side and the image plane side of the light amount adjusting unit 415, the two guide bars 410 and 411 for guiding the lens holding members 412 and 414 in the optical axis direction, and the two linear encoders for detecting the positions of the lens holding members 412 and 414, it can be formed in a compact size.

The scale 428 of the first linear encoder disposed next to the guide bar 410 reduces displacement of the scale 428 due to backlash of the engaging portions 412a and 412b of the second lens holding member 412 engaging with the guide bars 410 and 411 to enable accurate detection of positions.

When the linear actuator and the linear encoder are disposed across the optical axis from the guide bar for guiding the lens holding member which is driven and whose position is detected by them, the linear encoder may be moved in the direction opposite to the driving direction with the guide bar as the supporting point at the start of the driving due to backlash at the engaging portion of the lens holding member engaging with the guide bar. This may reduce the accuracy of the position detection. In this embodiment, however, the linear actuator and the linear encoder are disposed on the same side as the guide bar for guiding the lens holding member which is driven and whose position is detected by them, so that such a problem does not arise and the position can be detected accurately.

In addition, since the second linear actuator is disposed next to the guide bar 411, the fourth lens holding member 414 can be driven smoothly.

In this embodiment, the vibration type linear actuator is used to drive the lens for varying magnification which is generally driven less frequently than the lens for focusing. This enables reducing the size of the optical apparatus as compared with a case where an electromagnetic type linear actuator is used to drive the lens for varying magnification. On the other hand, the electromagnetic type linear actuator in which the coil and the magnet are not in contact with each other is used to drive the lens for focusing which is generally driven frequently than the lens for varying magnification. This enables increasing the durability of the optical apparatus as compared with a case where a vibration type linear actuator is used to drive the lens for focusing. Thereby, it is possible to realize a compact optical apparatus with a high durability.

The preferred embodiment of the present invention has been described. However, the present invention is not limited to the structure described in the embodiment, and various modifications may be made in the embodiment.

For example, although the description was made of the case where the vibrator of the vibration type linear actuator was fixed and the slider was moved together with the lens holding member in the optical axis direction, the present invention includes a configuration in which the slider is fixed and the vibrator is moved together with the lens holding member.

Moreover, although the description was made of the case where the coil of the electromagnetic type linear actuator was fixed and the magnet was moved together with the lens holding member in the optical axis direction, the present invention includes a configuration in which the magnet is fixed and the coil is moved together with the lens holding member.

While the embodiment has been descried in conjunction with the image-taking apparatus integral with the lens, the present invention is applicable to an interchangeable lens (optical apparatus) which is removably mounted on an image-taking apparatus body. The present invention is applicable not only to the image-taking apparatus, but also to various optical apparatuses for driving a lens by a vibration type linear actuator.

While the embodiment has been described in conjunction with the holding mechanism which holds the vibrator and the slider at variable positions and inclinations, it is possible to provide a holding mechanism which allows one of the position and inclination to be variable.

This application claims a foreign priority benefit based on Japanese Patent Application No. 2005-125749, filed on Apr. 22, 2005, which is hereby incorporated by reference herein in its entirety as if fully set forth herein.

What is claimed is:

1. An optical apparatus comprising:
a first lens which is moved in an optical axis direction for varying magnification;
a second lens which is moved in the optical axis direction for focusing;
a vibration type linear actuator which drives the first lens with vibration produced through an electromechanical energy conversion action; and
an electromagnetic type linear actuator which drives the second lens with electromagnetic power.

2. The optical apparatus according to claim 1, wherein the second lens is moved in the optical axis direction for correcting image plane changes associated with the movement of the first lens and for focusing.

3. The optical apparatus according to claim 1, wherein the vibration type linear actuator includes a vibrator on which vibration is produced through the electromechanical energy conversion action and a contact member which is in contact with the vibrator, and
the electromagnetic type linear actuator includes a coil and a magnet which faces without being in contact with the coil.
